(19) United States
(12) Patent Application Publication
(10) Pub. No.: US 2006/0142413 A1
(43) Pub. Date: Jun. 29, 2006

(54) Antimicrobial active borosilicate glass

(76) Inventors: Jose Zimmer, Ingelheim (DE); Jorg Fechner, Mainz (DE); Karine Seneschal, Mainz (DE); Wolfram Beier, Essenheim (DE)

Correspondence Address: BAKER & DANIELS LLP;111 E. WAYNE STREET, SUITE 800, FORT WAYNE, IN, 46802, US

(21) Appl. No.: 10/546,580

(22) PCT Filed: Feb. 24, 2004
(86) PCT No.: PCT/EP04/01805

§ 371 Date: Aug. 23, 2005

(30) Foreign Application Priority Data
Feb. 25, 2003 (DE) 103 07 839.8
Mar. 27, 2003 (WO) PCT/EP03/03158
Feb. 19, 2004 (WO) PCT/EP04/01572
Feb. 20, 2004 (WO) PCT/EP04/01670

(51) Int. Cl. C03C 3/089; C03C 10/00; C09D 5/16

(52) U.S. Cl. 523/122; 501/65; 501/2

(57) ABSTRACT

The invention relates to an antibacterial borosilicate glass having the following composition in relation to an oxide base: 40-80 mass % SiO₂, 5-40 mass % B₂O₃, 0-10 mass % Al₂O₃, 0 30 mass % P₂O₅, 0-25 mass % Na₂O, 0-25 mass % K₂O, 0-25 mass % CaO, 0-15 mass % MgO, 0-15 mass % SrO, 0-15 mass % BaO, 0-30 mass % ZnO, 0-5 mass % Ag₂O, 0-10 mass % CuO, 0-10 mass % GeO₂, 0-15 mass % TeO₂, 0-10 mass % Cr₂O₃, 0-10 mass % J, 0-10 mass % F. The percentage sum ZnO+Ag₂O+CuO+GeO₂+TeO₂+Cr₂O₃ +B₂0₃ ranges from 5 to 70 mass %.

The invention relates to an antimicrobial glasses, glass ceramics, in particular, glass powder and glass ceramics powder, fiberglass, glass granulates, glass balls on the basis of borosilicate glasses which have antimicrobial effect.

From U.S. Pat. No. 5,290,544, water dissolvable glasses possessing very low SiO₂ concentration and very high B₂O₃ concentration, that is, B₂O₅ concentration are known for application in cosmetic products. The glasses have a silver concentration of >0.5 wt %. The disadvantage of these glasses is that they have an extremely low hydrolytic resistance and, therefore, in powder form, in particular, they have the tendency to react with moisture. This makes it difficult to store and process these glass powders. These powders usually completely dissolve in water. During this process, Ag- and/or Cu-ions are released which have antibacterial effect. Even in JP-A-92178433A, water dissolvable glass powders are described which possess a Sio₂ concentration <37 wt % as polymeric addition having high silver concentrations >1 wt %.

The following pamphlets describe antibacterial borosilicate glasses:
JP-A00203876
JP-A01226139
JP-A95048142
JP-A95025635
JP-A11029343
JP-A61133813
JP-A11029343

In the biocide glasses, which were used previously, the glasses have a relatively low SiO₂ concentration and a relatively high B₂O₃ concentration, in order to realize the highest possible reactivation of the glasses.

JP 11029343 describes glasses containing no silver, which have a zinc concentration that is greater than 25 wt %. Of disadvantage are the high crystallization tendency and the related relatively difficult production of the glasses. In addition, the glasses disclosed in this pamphlet have an Na₂O concentration that is lower than 4 Mol %.

All glasses cited in prior art also do not concern distinctly decomposed glasses. The glasses cited in prior art have the disadvantage that no specific long-term release, for instance, of Ag could be realized.

The first objective of the invention is to avoid the disadvantages of prior art and to provide antimicrobial-acting glass which releases biocide-acting ions or components, and the dissolubility or the ion release of which could be distinctly adjusted in liquidly, in particular, watery solutions.

The glass or the subsequently produced glass ceramics, or the subsequently produced glass ceramics powder should have a biocide, though at least biostatic effect, toward bacteria, fungus, algae, as well as viruses. This objective is accomplished by means of glass involving a glass composition according to claims 1, 2, or 3. In addition, the invention also provides antimicrobial glass ceramics as well as glass powder extracted thereof.

The glasses or extracted glass ceramics according to the invention are usually distinctly decomposed glasses and have the advantage that by means of the degree of decomposing, the reactivation could be distinctly adjusted.

The glasses according to the invention are characterized by the fact that a distinct long-term release of ions, for instance, Ag ions, is realized, for instance, in the way that the borosilicate glass composition according to the invention is decomposed in a more rapid dissolvable phase and in a slower dissolvable phase. Another advantage of two-phase systems is the fact that the insoluble or sparingly soluble phase could even increase the mechanical strength, for instance, in polymers. The more sparingly soluble phase could, for instance, form a strutting three-dimensional “grid” in a polymer.

In a preferred embodiment, the invention-based compositions of glass, or subsequently produced glass ceramics, glass ceramics powder, or glass powder have a biocide, though at least biostatic, effect. However, it is compatible with human skin and toxicologically to a great extent harmless.

For these particular applications, the glass, subsequently produced glass ceramics, or glass ceramics powder has to fulfill special purity requirements in order to guarantee toxicological harmlessness. In this regard, there should be as little stress as possible through heavy metal. Desirable maximum concentrations in the area of cosmetic products are, for instance, Pb<20 ppm, Cd<5 ppm, As<5 ppm, Sb<10 ppm, Hg<1 ppm, Ni<10 ppm. These materials are used particularly for the realization of antimicrobial effect, for instance, in medical and food technology.

In another preferred embodiment, the invention-based glass, or subsequently produced glass ceramics, or the glass or glass ceramics powder, contain even heavy metals that release heavy metal ions. Therefore, they should not be used in direct contact with humans. These materials are particularly used to realize a potent biocide effect, for instance, in polymers, paints and varnishes, or anti-fouling products.

The glass matrix is composed from the group of non-heavy metals, and heavy metals are added only for particular application purposes in order to realize particularly potent biocide effect. Therefore, the glass, or glass ceramics, or subsequently produced glass or glass ceramics powder alone is non-toxic for humans. In this application, glass powder generally includes all forms of powder, that is, even fiberglass, glass granulates, glass balls, etc.

In the context of multiphase glasses and/or mixtures of glass in various compositions, in particular, it is possible to adjust complex time-dependent biocide effect. This could be attributed to the adjustability of the dissolubility and ion release, namely depending on the glass composition of individual glasses in a mixture or the individual glass phases in a multiphase system.

In contrast to highly alkaline antimicrobial glass powders, the pH value lies in the neutral to slightly alkaline range. [0017] If the invention-based glasses or subsequently produced glass ceramics, glass or glass ceramics powder come into contact with water, an ion exchange takes place between glass surface and a liquid medium, for instance, H₂O which surrounds the glass or glass ceramics.

In addition, the different phases dissolve more or less rapidly in the solution according to their hydrolytic resistance and also release ions.

Through variation of glass forming, that is, network-forming components, it is possible to adjust the dissolving speed of the entire network. This could result in a complete dissolubility of the glass. For instance, by reducing the SiO₂ concentration while, at the same time, increasing the alkaline or alkaline earth concentration, or the boric concentration, the dissolubility of the glasses is increased.

Effective antimicrobial effect is realized in form of glass powder with small grit size. This could be attributed to an adjustment of the reactive surface depending on the grit size.

In a particularly preferred embodiment, the invention-based glasses are phase decomposed, that is, at least two phases are formed within the glass with different compositions. This phase decomposition could even be produced during the process of melting or, in order to receive preferred phase proportions or greater decomposed areas, it could also be performed in a subsequent tempering step at the glass sheets, that is, the ribbons or the powder. These two or more phases thus produced within the glass could be glassy or crystalline.

The morphology, that is, the size and geometrical characteristics of the decomposing structures in the glass could be affected and adjusted through tempering.

Because of the different resistance of the phases, the watery systems have different release performances, that is, the different phases release biocide active ions at different speeds.

Phase decomposition could generate a highly reactive phase and a reactivity-reduced phase. In this context, the less reactive phase could even protect, at least to a certain extent, the highly reactive dissolvable phase against environmental stress.

The highly reactive phase, for instance, is a phase rich in borate, while the deferred phase is a silica-based phase.

Subsequently, different phase decomposed structures are described which are included in the invention.

The decomposed structures could be of spinodal or bimodal nature. This could generate interpenetration or droplet structures.

For structures with 2 phases, there are always three possible cases.

In the first case, the hydrolytic resistance of the first phase is greater than that of the second phase.

If the second phase were detached before the first phase could be decomposed, in this case, it would result in porosity. In this way, the decomposition process of the second phase is also affected through the diffusion process in the porosity.

If the first phase is not at all being decomposed and the second phase is an inclusion structure with structures in the nanometer area, despite the high dissolubility of the second phase, a long-term release by means of the diffusion-controlled release from the interior of the structure is being realized.

In the second case, the hydrolytic resistance of the first and second phase is basically identical. In such a case, the particles dissolve equally.

In the third case, the hydrolytic resistance of the first phase is lesser than that of the second phase. Then, particles of the second phase are released in the characteristic decomposition size.

For instance, if silver is present in both phases, the different phases could be adjusted to release the silver at different speeds. For instance, a fast silver release could be combined with a slower continuous silver release so that a continuous release is realized over a long period of time.

Another advantage for producing a highly reactive phase through phase decomposition is the fact that it is relatively easy to melt this system because of its overall composition. On the other hand, a melting of the individual phases being formed during decomposition is relatively difficult in the composition existing in each of the phases, because of the high crystallization tendency and/or melting temperature.

According to the invention, even borosilicate glasses with a high SiO₂ and a low B₂O₃ proportion which are easy to melt show biocide effect if they have comparatively small particles. In this context, preferred particle sizes are <100 μm and smaller <40 μm, particularly preferred are <20 μm and <10 μm. In an exceptionally preferred embodiment, the particles are <5 μm and <2 μm, that is, the phase decomposition in theses glasses increases reactivity.

The untempered source glass contains SiO₂ to form networks between 40-80 wt %, particularly preferred 40-77, exceptionally preferred 50-77 wt % SiO₂. In low concentrations, the spontaneous crystallization tendency increases considerably, and the chemical resistance decreases considerably. With higher SiO₂ values, the crystallization stability could decrease, and the processing temperature increases noticeably, weakening the hot shaping and melting characteristics.

B₂O₃ is added to the glass in order to adjust the stability of the glass network and, consequently, the reactivity of the glass. It is also required in order to produce a defined decomposition of the glass in at least two phases. In addition, B₂O₃ possesses antimicrobial characteristics which support synergistically the effect of antimicrobial active ions.

Na₂O act as fluxing agent in the process of melting glass. In addition, Na₂O affects the hydrolytic resistance of the glass and is an ion substitute for H⁺ ions in watery solutions. This could have a significant effect on the pH value in solutions or suspensions which are mixed with the glass powder.

K₂0 and/or Li₂O act as fluxing agent in the process of melting glass. In addition, through ion exchange, lithium and potassium ions could be released in place of H⁺ in watery systems and thus affect the pH value of these systems.

Because of the alkaline ion concentration, such as, Na⁺, Li⁺, K⁺, which perform an ion exchange with the watery solution, the pH value in the watery solution of suspension could be adjusted.

Through specific integration of network converters, such as alkaline oxides, the network forming is interrupted, and the reactivity of the glass is adjusted since, in high Na₂O concentrations, the network is looser and, in this respect, added biocide acting ions, such as, Zn, Ag could be easier released.

With regard to decomposed systems, Na₂O values between 5 and 15 wt % proved to be particularly preferred.

It is even possible [to produce] alkaline-free antimicrobial borosilicate glasses. Here, alkaline earth ions accept many functions of alkaline earth ions, for instance, those of the network converter.

Through combinations of the network modifying ions as, for instance, Na, Ca, Zn, etc. which increase the pH value because of the ion exchange with the surrounding watery medium, and the “acidic” non-bridgeable OH groups of the boric oxide which could be adjusted by means of the melting parameter and which decrease the pH value, the resulting pH value of the system could be distinctly adjusted in the area between 6-8.

In case of glass compositions in which the antimicrobial effect of the glass is being generated by means of ions such as zinc or even small concentrations of silver, this antimicrobial effect is supported by means of additionally released alkaline ions as, for instance, Na, K, or alkaline earth ions.

For applications in areas in which the glass, the subsequently produced glass ceramics, or the glass powder or glass ceramics powder comes in contact with humans, for instance, in applications in the area of medicine, cosmetics, etc., the glass should preferably be free from other heavy metals. In the context of such applications, it is preferred to use particularly pure raw materials.

The biocide or biostatic effect of the invention-based glass, or subsequently produced glass powder, or the invention-based glass ceramics produced from these source glasses, is generated through an ion release in a liquid medium, in particular, water. The glasses or subsequently produced glass powders and glass ceramics have biocide effect toward bacteria, fungus, as well as viruses. This effect is generated, in particular, because of the presence of zinc and/or silver. In addition, the release of boron could also generate antimicrobial effect.

In addition to the release, the antimicrobial glass surface released into the systems plays a part. The antimicrobial effect of the glass surface is also based on the presence of antimicrobial active ions. But it is also known that surface charges, that is, the zeta potential of powders could have antimicrobial effect, in particular, on gram-negative bacteria. For instance, positive surface charges on gram-negative bacteria generate antimicrobial effect, the positive surface charges attract bacteria, but gram-negative bacteria are not able to grow or increase on surfaces with positive zeta potential. In this regard, reference is made to Bart Gottenbo's et al. Materials in Medicine 10 (1999) 853-855, Surface of Polymers.

Antimicrobial effects in powders with positive surface charges are discussed in Speier et al. Journal of Colloid and Interface Science 89 68-76 (1982) Kenawy et al. Journal of controlled release 50, 145-52 (1998).

For applications in areas where there is no direct contact with humans, the invention-based glasses, glass powders, or glass ceramics could even possess higher concentrations of heavy metal ions in order to realize particularly strong biocide effect. Such heavy metal ions are Ag, Cu, Ge, Te, and Cr. Glasses, glass powders, or glass ceramics according to the invention could be added to polymers, paints and varnishes, and anti-fouling products.

By means of the P₂O₅ concentration, the chemical resistance of the glass and, consequently, the ion release in watery media could also be adjusted. The P₂O₅ value lies between 0 and 30 wt %. If the P₂O₅ value is higher than 30 wt %, the hydrolytic resistance of the glass ceramics becomes too low.

B₂O₃ is included as network-forming component and considerably affects the chemical resistance as well as the decomposition performance of the glass, particularly in the context of higher concentrations. In addition, it supports the antimicrobial effectiveness of the glass.

The Al₂O₃ concentration should be smaller than 10 wt % so that the chemical resistance does not become too high.

In order to intensify or produce antibacterial characteristics of the glass, or in order to support or initiate specific decomposition performances, additional ions as, for instance, Ag 1, Ce, Cu, Cr, Ge, Te, Br, Cl in concentrations lower than 15 wt % could be included.

The addition of silver often results in discoloration of the glass. Such discolorations could be avoided if silver is added to the glass in oxidative acting mixtures, for instance, as silver nitrate (AgNO₃). In addition, the glass is melted preferably under oxidizing conditions, for instance, by means of oxygen bubbling in order to realize an oxidizing condition in the glass and, consequently, avoid that the Ag⁺ is reduced to Ag⁰. This could also be realized by means of tray adjustments as, for instance, oxidative burner adjustments. By means of such procedures, by adding silver, discolorations in the glass as well as in the polymer during further processing could be avoided. Even other components as, for instance, alkaline, or alkaline earth could be added to the mixture as oxidative acting components as, for instance, nitrate, peroxide, etc. The described procedure to avoid discolorations of the glass could even be used with other glasses containing Ag, for instance, phosphate glasses with the following compositions in wt % on oxide basis:

| | | |
|---|---|---|
| P₂O₅ | >66-80 | wt % |
| SO₃ | 0-40 | wt % |
| B₂O₃ | 0-1 | wt % |
| Al₂O₃ | >6.2-10 | wt % |
| SiO₂ | 0-10 | wt % |
| Na₂O | >9-20 | wt % |
| CaO | 0-25 | wt % |
| MgO | 0-15 | wt % |
| SrO | 0-15 | wt % |
| BaO | 0-15 | wt % |
| ZnO | >0-25 | wt % |
| Ag₂O | 0-5 | wt % |
| CuO | 0-10 | wt % |
| GeO₂ | 0-10 | wt % |
| TeO₂ | 0-15 | wt % |
| Cr₂O₃ | 0-10 | wt % |
| J | 0-10 | wt % |
| F | 0-3 | wt % |

or sulphosphate glasses with the following compositions in Wt % on oxide basis:

| | | |
|---|---|---|
| P₂O₅ | 15-60 | wt % |
| SO₃ | 5-40 | wt % |
| B₂O₃ | 0-20 | wt % |
| Al₂O₃ | 0-10 | wt % |
| SiO₂ | 0-10 | wt % |
| Li₂O | 0-25 | wt % |
| Na₂O | 0-25 | wt % |
| K₂O | 0-25 | wt % |
| CaO | 0-40 | wt % |
| MgO | 0-15 | wt % |
| SrO | 0-15 | wt % |
| BaO | 0-15 | wt % |
| ZnO | 0-45 | wt % |
| Ag₂O | 0-5 | wt % |
| CuO | 0-10 | wt % |
| GeO₂ | 0-10 | wt % |
| TeO₂ | 0-15 | wt % |
| Cr₂O₃ | 0-10 | wt % |
| J | 0-10 | wt % |
| F | 0-5 | wt % |

whereby the sum ZnO+Ag₂O+CuO+GeO₂+TeO₂+Cr₂O₃+J lies in the area from >0.01 to 45 wt %.

The total concentrations of nitrate in raw material mixtures preferably amount to more than 0.5 or 1 wt %, particularly preferred more than 2.0 wt %, exceptionally [preferred] more than 3.0 wt %.

In addition, ions such as Ag, Cu, Au, Li could be included as an addition in order to adjust the high temperature conductibility of the melt and, consequently, for an improved fusibility with HF melting procedures.

Color supplying ions, such as, Fe, Cr, Co, V, Ce, Cu, Er, and Ti could be included individually or combined in total concentrations smaller than 1 wt %.

According to another aspect of the invention, an antimicrobial glass with high fungicide effect should be provided that is as water unsolvable as possible.

Unexpectedly, it was possible to determine a particularly strong fungicide effect if the glass compositions contained germanium and/or tellurium with proportions greater than 10 ppm, but smaller than 15 wt %. It is preferred to have an area greater than 10 ppm, but smaller than 5 wt %; particularly preferred greater than 10 ppm, but smaller than 1.5 wt %; exceptionally preferred greater than 10 ppm, but smaller than 0.9 wt %.

This high fungicide effect was particularly found even in water unsolvable silicate glasses with proportions of SiO₂ from 35-70 wt %. The extremely strong fungicide and antimicrobial effect of the glass results from a synergistic effect between the fungicide and antimicrobial effect of tellurium and/or germanium as well as possibly present heavy metal ions Ag, Cu, Zn, and the effect of an ion exchange in the glass. By means of reactions on the surface of the glass, alkalis of the glass are exchanged with H+ ions of the watery medium. The fungicide and antimicrobial effect of the ion exchange, among other things, is based on an increase of the pH value and the osmotic effect on microorganisms.

Ion exchangeable glasses, as here described, act in watery solutions antimicrobial through an increase of the pH value through an ion exchange between Na and Ca and the H+ ions of the watery solution as well as through an ion-dependent impairment of cell growth, in particular, an osmotic pressure or a disruption of the metabolism process in the cells. Depending on the particle size, concentration, and composition of the powder, pH values of up to 13 could be realized.

With regard to the tellurium and germanium containing glasses, the glass composition contains SiO₂ as network-forming component between 35-70 wt %. In low concentrations, the hydrolytic resistance decreases considerably so that grinding in watery media could no longer be guaranteed without significant dissolution of the glass.

With higher values, the crystallization stability could decrease and the processing temperature increases, weakening the melting and hot shaping characteristics.

Na₂O is used in silicate glasses as fluxing agent in the process of melting glass. In concentration smaller than 5%, the melting performance is affected negatively. In addition, the necessary mechanism of the ion exchange is no longer adequate in order to realize antimicrobial effect. In Na₂O concentrations higher than 30 wt %, an impairment of the chemical resistance or hydrolytic resistance could be observed, in particular, in the context of a decrease of the SiO₂ proportion.

P₂O₅ is a network-forming component in silicate glasses and could increase the crystallization stability. The concentrations should not be above 15 wt %, since otherwise the chemical resistance of the silicate glasses decreases too much. P₂O₅ improves the surface reactivity of the glasses. Through the concentration of P₂O₅, the pH value of the suspension in watery media could be adjusted.

With regard to the silicate glasses, CaO improves the chemical resistance, particularly in the slightly alkaline area and is therefore required in order to avoid the dissolution of the glass in watery media.

K₂O additions promote the exchangeability of sodium, that is, potassium itself could be exchanged with H+ ions.

With silicate glasses, a concentration of Al₂O₃ could be added in order to increase the crystallization stability of up to a maximum of 8 wt %.

ZnO is an essential component for the hot shaping characteristics of silicate glass. It improves the crystallization stability and increases the surface stress in addition, it could support the antibacterial effect. In small SiO₂ values, it increases the crystallization stability. In order to realize a fungicide as well as antimicrobial effect, in addition to the germanium or tellurium up to 8 wt % ZnO could be included. A preferred embodiment contains smaller than 4 wt % ZnO or smaller than 2 wt %. Embodiments smaller than 1 wt % or 0.5 wt % or smaller than 0.1 wt % are particularly preferred.

With germanium or tellurium containing borosilicate glasses as well as with silicate glasses, TeO₂, GeO₂, Ag₂O, CuO are antibacterial additions that strengthen synergistically the intrinsic antibacterial effect of the source glass—either the silicate glass or the borosilicate glass. As a result, comparatively small concentrations of TeO₂, GeO₂ have to be added in order to realize fungicide effect.

The sum of the TeO₂, GeO₂ concentrations is smaller than 15 wt %, in particular smaller than 5 wt %. In a preferred embodiment, the concentration is smaller than 2 wt %, preferably 1 wt %. An exceptionally preferred embodiment contains concentrations of smaller than 0.5, in particular, 0.2 wt %. An exceptionally preferred embodiment contains concentrations of smaller than 0.1, in particular, 0.05, in particular, 0.01 wt %. The lower effective TeO₂, GeO₂ concentration is 0.001 wt %.

Because of synergistic effect, the sum of the TeO₂, GeO₂ concentrations in glasses that contain more than one of these components each lies below the added concentrations in glasses which contain only one of these oxide components respectively, that is, GeO₂ or TeO₂ alone. Even in the production of glass compositions by means of high frequency procedures, there are special advantages in providing Te and Ge additions since, in this way, the possibility of melting connections is increased.

Through a combination of pH effect and Ge, Te releases, a considerable increase of fungicide and antimicrobial effect in the tellurium and germanium containing glass combinations could be realized, which noticeably exceeds the sum of individual effects. Here, the concentration of Te ions which are released into the product could lie noticeably below 1 ppm.

Here, the release of Te or Ge could take place as early as during the melting process by means of adequate tellurium/germanium salts or by means of an ion exchange of the glass after the melting process.

The tellurium or germanium containing glasses within the required composition areas fulfill all requirements to be used in the areas of paper hygiene, cosmetics, paints, varnishes, cleaning supplies, medical products, cosmetic applications, food supplements, as well as deodorant products.

The glass or glass ceramics are usually used in powder form, producing particle sizes of <100 μm in the grinding process. In this regard, particle sizes of <50 μm or 20 μm prove to be practical. Particularly practical are particle sizes of <10 μm or smaller than 5 μm exceptionally practical prove to be particle sizes of <1 μm.

The grinding process could be performed in watery as well as non-watery grinding media.

It is possible to produce mixtures of different glass powders or glass ceramics with different compositions and grain sizes in order to combine effects such as release rates or long-term releases. For instance, glass with low hydrolytic resistance for the realization of a quick short-term effect could be combined with glass of higher hydrolytic resistance for the simultaneous realization of a long-term release. Similar effects could be realized through combinations of different particle sizes or particle size distributions.

The release of biocide ions could be attributed to ion-exchange processes with the water or other solvents as well as dissolution processes of the glass powder.

The adjustment of timed-release performances is controlled through the particle size and, consequently, the specific surface of the powder, the grain size distributions as well as the glass compositions.

In contrast to the completely dissolvable glasses, the release affects the ion exchange in watery systems. For instance, Ag⁺ ions are replaced by H⁺ ions in the glass.

It is known that surface charges could realize antimicrobial effect. Glass particles that are not completely dissolvable, could also realize antimicrobial effect by means of their surface charge. Microbes are attracted and killed at the glass surface, or are unable to reproduce, by means of ions and/or local high pH values.

Despite their relatively high hydrolytic resistance, the glasses according to the invention are characterized by adequate antimicrobial effect. In this way, it is possible to reduce or avoid to a large extent the hygroscopic characteristics of the water soluble glasses which would be harmful for shipping and storage conditions of the glasses.

The glasses described here or the subsequently produced glass ceramics, glass ceramics powder, or glass powder are particularly suitable for use in medical products, in paints and varnishes, in plaster, hard plaster, ceramics, cement and concrete, floor coverings, in anti-fouling products, in cosmetic products, hygiene products, personal care products, in dental applications, products for oral and mouth hygiene, in polymers, food processing, in foods.

In particular, they are suitable for use in the following products, for instance, as antimicrobial addition in polymers:
Cutting boards, gloves,
Garbage cans,
Knife handles,
Cutlery, for instance, chopsticks,
Trays,
Table cloths,
Carpeting,
Refrigerators,
Food containers,
Dish washers,
Dryers,
Telephones,
Keyboards, displays,
Electric irons,
Rice cookers.

In automotive engineering, for instance, the following applications are possible:
Steering wheels,
Automobile controls,
Arm rests,
Keys,
Doorknobs,
Ashtrays,
Switch buttons,
Switches,
Adjusting knobs.

In addition, the glasses, or the subsequently produced glass ceramics, glass powder, or glass ceramics powder are suitable for use, in particular, as antimicrobial additions in polymers for:
Ball pens,
Disks,
Audio, videocassettes,
Compact disks (CD),
Clipboards.

In addition, such glasses, glass ceramics, glass powder, or glass ceramics powder could even be used in the area of clothing industry, preferably included in synthetic fiber materials. It could possibly be used in:
Articles of clothing,
Socks,
Underwear,
Towels,
Toilet cloths,
Wallpaper,
Pillowcases,
Pillow fillings,
Bathing suits,
Bathing caps,
Carpeting.

Other products on a synthetic fiber or polymer basis that could be included in the invention-based glass, the invention-based glass ceramics, subsequently produced glass powder or glass ceramics powder are:
Carpeting,
Contact lenses,
Contact lenses containers,
Playing sand,
Plastic money,
Paper money,
Toys,
Wristwatches,
Diving suits,
Adhesives,
Plastic gaskets.

In particular, the antimicrobial glass powder is suitable to be used for carpeting as an added component to the fibers.

A particularly preferred application of the described glasses is the use in dental materials, in particular, for dental fillings, crowns, inlets.

In this regard, it is particularly preferred to use it as composite material with polymer materials.

Without restricting the use of the described glasses in the polymer area, there are polymers which are especially suitable for a bio glass addition. These are, in particular, PMMA; PVC; PTFE; polystyrene; polyacrylate; polyethylene; polyester; polycarbonate; PGA biodegradable polymer; LGA biodegadeable polymer; or the biopolymer collagen; fibrin, chitin; chitosan; polyamides; polycarbonates; polyester; polyimides; polyurea; polyurethanes; organic fluoropolymers; polyacrylamides and polyacryl acids; polyacrylates; polymethacrylates; polyolefines; polystyrenes and styrene-copolymers; polyvinyl ester; polyvinyl ether; polyvinylidene chloride; vinyl polymers; polyoxymethylen; polyaziridine; polyoxyalkylene; synthetic resins or acrylic resins, amino resins, Epoxy resins, phenolic resins or unsaturated polyester resins; electro conductive polymers; high temperature polymers; inorganic polymers; polyphenyl oxide silicones; biopolymers, such as, cellulose, cellulose ester, cellulose ether, enzymes, gelatin, natural resins, nucleic acids, polysaccharides, proteins, silk, starch, or wool.

By means of the following pictures and embodiments, a further description of the invention is provided.

It is shown:

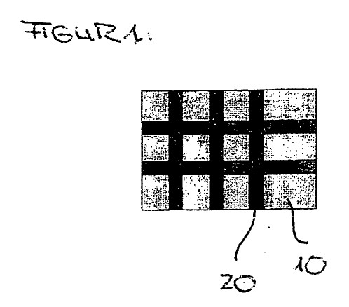

FIG. 1: basic representation of a two-phase system.

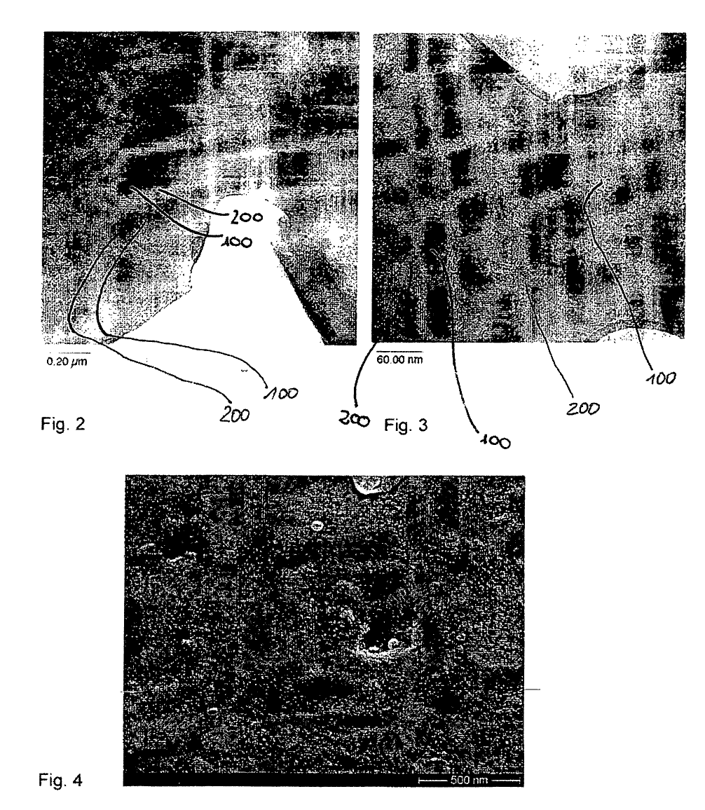

FIGS. 2, 3 TEM pictures of glass with a glass composition according to embodiment 1.

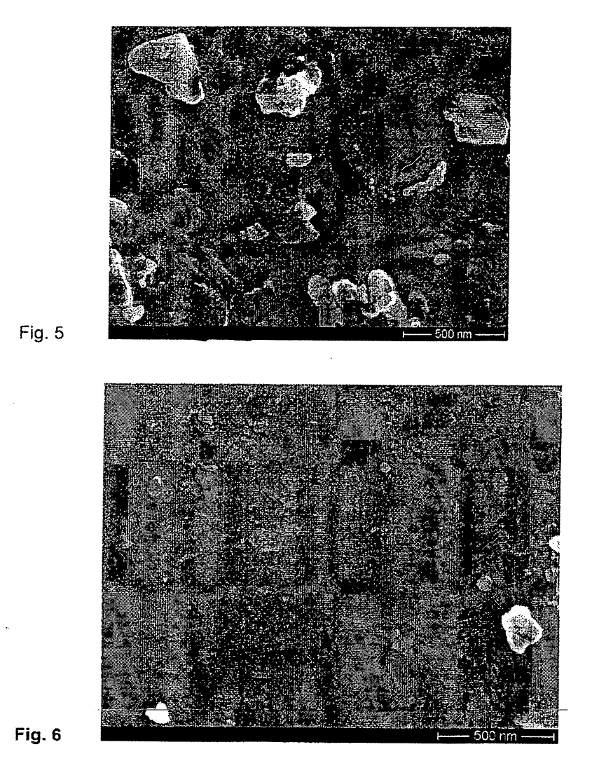

FIGS. 4, 5 REM pictures of glass with a glass composition according to embodiment 12.

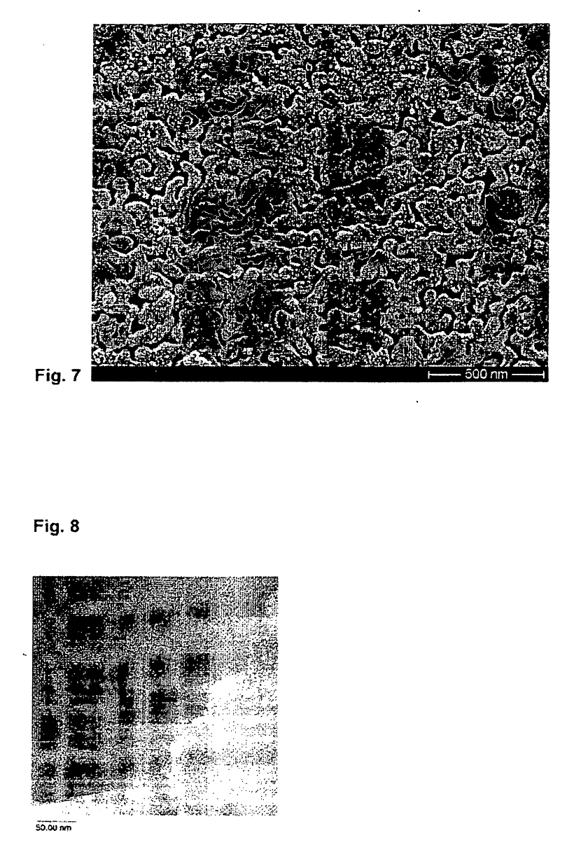

FIGS. 6, 7 REM pictures of glass surfaces of glass with a glass composition according to embodiment 12.

FIG. 8 REM picture of the surface of glass with a glass composition according to embodiment 14a.

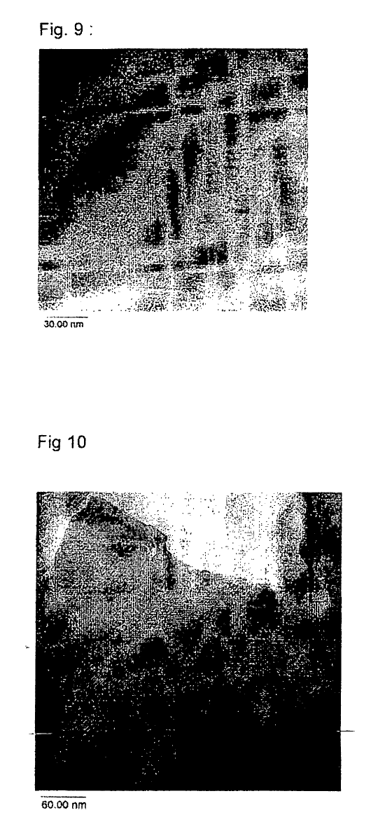

FIG. 9 Surface of glass with a glass composition according to embodiment 12.

FIG. 10 Surface of glass with a glass composition according to embodiment 12, tempered according to embodiment 12c.

First of all, embodiments for borosilicate glasses according to the invention of basic glasses will be provided which do not require specific treatment in order to realize a phase decomposed system.

The glasses were obtained by melting glass form raw materials which was subsequently shaped into ribbons. By means of dry refining, these ribbons were processed into powder with a particle size of d50=4 μm.

Table 1 shows glass compositions in wt % on oxide basis of borosilicate glasses according to the invention.

TABLE 1
Glass compositions in wt % on oxide basis of borosilicate glasses according to the invention.

| | | | | | | | | | | | | | | | | E | E | E | E |
|---|---|---|---|---|---|---|---|---|---|---|---|---|---|---|---|---|---|---|---|
| | E 1 | E 2 | E 3 | E 4 | E 5 | E 6 | E 7 | E 8 | E 9 | E 10 | E 11 | E 12 | E 13 | E 14 | E 15 | 16 | 17 | 18 | 19 |
| SiO₂ | 63.5 | 63.5 | 62.5 | 71 | 61 | 68.67 | 61 | 61 | 64.5 | 63 | 56 | 63.5 | 77 | 70 | 63.5 | 61 | 61 | 55 | 65 |
| B₂O₃ | 30 | 29.9 | 28 | 21 | 21 | 16.63 | 22 | 36 | 25.5 | 22 | 18 | 29 | 14.5 | 10.7 | 29 | 37 | 30 | 35 | 33 |
| Al₂O₃ | | | 4 | | | 2.46 | | | | | 6.63 | | 4 | 4 | | | 2 | | |
| P₂O₅ | | | | | | 2.45 | | | | | | | | | | | | | |
| Na₂O | 6.5 | 6.5 | 5 | 7 | | | 3 | 2.99 | 5 | 6.99 | 3.7 | 6.5 | 3.5 | 2.8 | 5.5 | | 5 | 8 | |
| Li₂O | | | | | | | | | | | 1.84 | | | | | | | | |
| K₂O | | | | | | | 4 | | | | 5.64 | | 1 | 3.6 | | | | | |
| BaO | | | | | | | | | | | | | | | | | | | |
| CaO | | | | | | 2.94 | | | | | | | | 2.1 | | | | | |
| MgO | | | | | | | | | | | | | | | | | | | |
| SrO | | | | | | | | | | | | | | | | | | | |
| ZnO | | | | | 18 | | 9.95 | | | 10 | 0.28 | | | 2.5 | | | | | |
| SO₂ | | | | | | | | | | | 5.37 | | | | | | | | |
| Ag₂O | | 0.1 | 0.5 | 1 | | 0.5 | 0.05 | 0.01 | 5 | 0.01 | 0.21 | 1.0 | | | 2 | 2 | 1 | 2 | 2 |
| CuO | | | | | | | | | | 2 | 2.07 | | | | | | | | |
| GeO₂ | | | | | | | | | | | | | | | | | | | |
| TeO₂ | | | | | | | | | | 1 | 0.04 | | | | | | 1 | | |
| Cr₂O₃ | | | | | | | | | | 1 | 0.01 | | | | | | | | |
| ZrO₂ | | | | | | | | | | | | | | 4.75 | | | | | |
| Jod | | | | | | | | | | | 0.01 | | | | | | | | |
| Br | | | | | | | | | | | | | | | | | | | |
| Cl | | | | | | | | | | | | | | | | | | | |

[E = embodiment]

Embodiment 6 in table 1 describes glass ceramics which. By means of tempering, the proportion of the produced Apatite phase could be affected. The crystalline phase of the glass ceramics is a Ca₃(PO₄)₂-(Apatite)-phase. If the glass ceramics, for instance, the subsequently produced glass ceramics powder, comes into contact with water, a hydroxyl-Apatite layer is formed.

Table 2 shows glasses that underwent a defined tempering process. By means of this tempering, a defined decomposition was realized. The glasses were melted from the raw materials for each of the embodiments mentioned in table 1 and afterwards formed into ribbons. Then, the tempering on the ribbons was performed at the specified temperatures and for the time periods mentioned in table 2. In table 2, the tempering temperature, the tempering time, as well as the size of the decomposed areas, the so-called decomposition size for the different glass compositions according to table 1 is specified.

TABLE 2
Size of the decomposed areas for different glass compositions at different
temperatures and tempering times

| | Glass | | | | Decompo- | |
|---|---|---|---|---|---|---|
| | composition | Tempering | Temperature | Time | sition | |
| Specimen | acc. to table 1 | On | (° C.) | (h) | size | |
| E 1-a | Embodiment 1 | Ribbon | 560 | 10 | 30 | nm |
| E 1-b | Embodiment 1 | Ribbon | 560 | 20 | 60 | nm |
| E 1-c | Embodiment 1 | Ribbon | 620 | 10 | 40 | nm |
| E 1-d | Embodiment 1 | Ribbon | 620 | 20 | 80 | nm |
| E 2-a | Embodiment 2 | Ribbon | 560 | 10 | 40 | nm |
| E 2-b | Embodiment 2 | Ribbon | 560 | 20 | 100 | nm |
| E 2-c | Embodiment 2 | Ribbon | 620 | 10 | 70 | nm |
| E 2-d | Embodiment 2 | Ribbon | 620 | 20 | 150 | nm |
| E 12-a | Embodiment | Ribbon | 560 | 10 | 50 | nm |
| | 12 | | | | | |
| E 12-b | Embodiment | Ribbon | 560 | 20 | 150 | nm |
| | 12 | | | | | |
| E 12-c | Embodiment | Ribbon | 620 | 10 | 80 | nm |
| | 12 | | | | | |
| E 12-d | Embodiment | Ribbon | 620 | 20 | 200 | nm |
| | 12 | | | | | |
| E 14-a | Embodiment | Ribbon | 820 | 5 | 40 | nm |
| | 14 | | | | | |

[E = embodiment]

Tables 3 through 5 show antimicrobial effect for different embodiments of glass compositions according to table 1. In all cases, the determination of antimicrobial effect is based on measurements from glass powders that were derived from the glasses of the respective glass compositions being produced through grinding of the ribbons. A tempering on ribbons was only mentioned for the glass powder mentioned in table 3. The starting values, for instance, identify the number of 350,000 Ecoli bacteria introduced at the beginning of the test. The value of 0 shows antimicrobial effect of the invention-based glass since subsequently no bacteria could be detected in the suspension.

TABLE 3
Antibacterial effect of glass powder according to European
pharmacopoeia (Third edition) for a glass composition according to
embodiment 2 in table 1 with a particle size of 4 μm in a
watery suspension at a concentration of 0.01 wt %. The glass
was not tempered before grinding.

| | | P. | | C. | |
|---|---|---|---|---|---|
| | E coli | aeruginosa | S. aureus | albicans | A. niger |
| Start | 350,000 | 250,000 | 270,000 | 333,000 | 240,000 |
| 2 days | 0 | 0 | <100 | 0 | 240,000 |
| 7 days | 0 | 0 | 0 | 0 | 180,000 |
| 14 days | 0 | 0 | 0 | 0 | 50,000 |
| 21 days | 0 | 0 | 0 | 0 | 16,000 |
| 28 days | 0 | 0 | 0 | 0 | 4,000 |

TABLE 4
Antibacterial effect of glass powder according to European
pharmacopoeia (Third edition) for a glass composition according
to embodiment 12 with a particle size of 4 μm in a watery suspension
and a concentration of 0.001 wt %. Before the grinding, the glass was
tempered, as in embodiment 12c according to table 2, at 620° C.
for 10 h on ribbon resulting in a two-phase decomposed glass with
a decomposition size of 80 nm.

| | | P. | | C. | |
|---|---|---|---|---|---|
| | E coli | aeruginosa | S . aureus | albicans | A. niger |
| Start | 270,000 | 260,000 | 260,000 | 240,000 | 240,000 |
| 2 days | 0 | 0 | 0 | <100 | 180,000 |
| 7 days | 0 | 0 | 0 | 0 | 100,000 |
| 14 days | 0 | 0 | 0 | 0 | 60,000 |
| 21 days | 0 | 0 | 0 | 0 | 12,000 |
| 28 days | 0 | 0 | 0 | 0 | 6,000 |

TABLE 5
Antibacterial effect of glass powder according to European
pharmacopoeia (Third edition) for a glass composition according
to embodiment 11 in table 1 with a particle size of 4 μm in a
watery suspension and a concentration of 0.1 wt %. The glass was
not tempered before grinding.

| | | P. | | C. | |
|---|---|---|---|---|---|
| | E coli | aeruginosa | S. aureus | albicans | A. niger |
| Start | 290,000 | 220,000 | 250,000 | 270,000 | 280,000 |
| 2 days | 0 | 0 | 100 | <100 | 100,000 |
| 7 days | 0 | 0 | 0 | 0 | 30,000 |
| 14 days | 0 | 0 | 0 | 0 | 22,000 |
| 21 days | 0 | 0 | 0 | 0 | 14,000 |
| 28 days | 0 | 0 | 0 | 0 | 14,000 |

Subsequently, the antimicrobial effect of glass powder is shown which has a particle size of d50 4 μm and a glass composition according to embodiment 12 in table 1 for an untempered specimen and a tempered specimen in a proliferation test.

The proliferation test is a test procedure by means of which the effectiveness of antimicrobial surfaces could be quantified. In simple terms, this means that the antimicrobial effect of the surface characterizes whether and to what extent daughter cells are released into the surrounding growing medium.

In addition, proliferation tests for glasses of a glass composition according to embodiment 1 and 11 in table 1 are described.

Staph epidermis was used as germ. This is a germ that could be found on skin.

The performance of proliferation tests is described in T. Bechert, P. Steinbrucke, G. Guggenbichler, Nature Medicine, Volume 6, Number 8, September 2000, pp. 1053-1056. The proliferation test is a test procedure by means of which the effectiveness of antimicrobial effect of the surface characterizes whether and to what extent daughter cells are released into the surrounding growing medium.

Table 6 shows the observed proliferation over a period of 48h for glass powder with a particle size between d50 of 4 μm and glass composition according to embodiment 12 which is homogeneously released into polypropylene (pp). The glass was not tempered before grinding.

TABLE 6
Proliferation over a period of 48 h for glass powder with a glass
composition according to embodiment 12, which was homogeneously
released into polypropylene (pp)

| | 0.20% | 2.00% |
|---|---|---|
| Onset OD (absolute) | 11.5 | 20.7 |
| Estimation | antibacterial | antibacterial |

Onset OD is the optical density in the surrounding growing medium. The proliferation (the forming of daughter cells) and the release of cells from the surface into the surrounding growing medium results in disturbance of the transmission of the growing medium. This absorption in the context of specific wavelengths correlates with the antimicrobial effect of the surface. The higher the onset OD value the more antimicrobially effective is the surface.

In comparison, table 7 shows the proliferation over a period of 48 h for glass powder with a glass composition according to embodiment 12 in table 1 which, before grinding according to embodiment 12-c in table 2, has been tempered for 10 h at 620° C. The glass powder was homogeneously released into polypropylene (pp) as defined decomposed powder.

TABLE 7
Proliferation over a period of 48 h for glass powder with a glass
composition according to embodiment 12-c:

| | 0.20% | 0.50% | 2.00% | 5.00% |
|---|---|---|---|---|
| Onset OD | 13.7 | 15.9 | 23.8 | 32.0 |
| (absolute) | | | | |
| Estimation | slightly | antibacterial | highly | highly |
| | antibacterial | | antibacterial | antibacterial |

It is evident that the defined decomposition of the glass results in an increase of the antimicrobial effect.

Subsequently, by way of comparison, tables 8 and 9 show the performance of the proliferation test on a glass surface with a glass composition according to embodiment 1 and 11 according to table 1. This [test] involves glass cubes 5×5×4 mm in size, no glass powder.

The tests were performed with massive glass cubes (not introduced into polymermatrix).

TABLE 8
Proliferation test for glass with a glass composition according to
embodiment 1 in table 1:

| | Embodiment 1 |
|---|---|
| Onset OD | >48 |
| (absolute) | |
| Estimation | bactericide |

TABLE 9
Proliferation test for glass with a glass composition according to
embodiment 11 in table 1.

| | Embodiment 1 |
|---|---|
| Onset OD | 12.8 |
| (absolute) | |
| Estimation | Slightly antibacterial |

FIGS. 1 through 10 show invention-based two-phase glass systems.

FIG. 1 is a basic representation of a structure. The first phase (light colored) is marked with 10 and the second phase (dark colored) with 20. If the hydrolytic resistance of the first phase is considerably greater than that of the second phase, the second phase will be detached from the first phase before the first phase could be decomposed. This results in porosity so that the decomposition process of the second phase is also affected through the diffusion process in the porosity. If the first phase is not at all being decomposed and the second phase is an inclusion structure with structures in the nanometer area, despite the high dissolubility of the second phase, a long-term release is being realized, namely by means of a diffusion-controlled release from the interior of the structure. By means of the detaching procedure, for instance, in watery solutions, a porous structure is formed with definite speed, depending on the hydrolytic resistance and reactivity.

If the hydrolytic resistance of both phases is equal, both are dissolved equally. If the hydrolytic resistance of the first phase (10) is considerably smaller than that of the first phase (20), particles from the second phase are released in characteristic decomposition size.

In embodiment 6 in table 1, glass ceramics are described which, depending on reaction conditions, could release Apatite or hydroxyl Apatite. Here, the crystallite sizes, depending on melting and tempering condition, lie within a magnitude of between 100-2,000 nm.

The decomposition of glasses could be realized either by means of a primary melting and hot shaping process through an appropriate choice of temperature control, or by means of subsequent tempering of ribbons, frits, or glass powders. Usually, the decomposition temperatures would be in a range of Tg up to Tg+200° C., preferably Tg+100° C., particularly preferable Tg+50° C. Tg refers to the transformation temperature according to Schott-Guide to Glass, second edition, pp. 18-20, or VDI-Lexikon Werkstofftechnik (1993), pp. 375-376.

Depending on the desired decomposition structure, the appropriate duration and temperature of the process could be selected.

FIGS. 2 and 3 show transmission electron microscope recordings (TEM recordings) of decomposed glasses. FIGS. 2 and 3 show TEM recordings of glasses with a glass composition according to embodiment 1 in table 1, tempered according to embodiment 1a at 560° C. for 10 h.

As seen in FIGS. 2 and 3, the embodiment shown in FIGS. 2 and 3 is a two-phase system. The first phase is marked with 100 and the second phase with 200. This decomposition concerns spinodal decomposition and, consequently, the structure concerns diffusion structure.

The decomposition of glasses could be realized either by means of a primary melting and hot shaping process through an appropriate choice of temperature control, or by means of subsequent tempering of ribbons, frits, or glass powders. Usually, the decomposition temperatures would be in a range of Tg up to Tg+200° C., preferably Tg+100° C., particularly preferable Tg+50° C.

Depending on the desired decomposition structure, the appropriate duration and temperature of the process could be selected. In this regard, it is referred to table 2.

FIGS. 4 and 5 show REM pictures of glass with a glass composition according to embodiment 12.

FIG. 4 shows the glass surface of glass with a glass composition according to embodiment 12, which was not tempered. It does not snow any decomposition.

FIG. 5, in turn, shows the glass surface of glass with a glass composition according to embodiment 12, which was treated in water for 1 h. As a result, the glass surface interacted with the surrounding watery solution and began to liquefy.

By way of comparison, FIGS. 6 and 7 show REM pictures from glass surfaces of glasses with a glass composition according to embodiment 12 in table 1 which were tempered for 10 h at 620° C. according to embodiment 12-c in table 2. FIG. 6 shows a glass surface which did not have any exposure. FIG. 7 shows a glass surface which had been treated in water for 1 h. The surfaces are glass powder surfaces produced from dry refining. The particle size amounts to 4 μm.

FIG. 6 clearly shows the decomposition in two phases. FIG. 7 shows the same specimen after water treatment for 1 h. The reactive phase is being detached; the less reactive structure remains intact. FIG. 8 shows a TEM picture of a glass surface with a glass composition according to embodiment 14 in table 1, tempered at 820° C. for 5 h.

FIG. 8 shows bimodal droplet decomposition according to embodiment 14-a.

FIG. 9 shows a TEM recording for glass with a glass composition according to embodiment 12.

In FIG. 9, the black spots correspond to silver (Ag). The silver shows a homogeneous distribution in the glass, with the silver not being concentrated in one phase.

FIG. 10 shows a TEM recording for glass with a glass composition according to embodiment 12 and tempered at 620° C. for 10 h according to embodiment 12-c in table 2.

The tempered glass in FIG. 10 shows a multiphase decomposition. The black spots show areas with a silver concentration which concentrate preferably in the light phase areas of the glass matrix. In comparison to FIG. 9, it is evident that the silver is not homogeneously distributed in the glass matrix. The lighter phase areas have a B₂O₃ concentration and represent the reactive phase.

The following table 10 mentions the pH values of a tempered glass powder according to embodiment 1-c with a particle size of 5 μm, in a watery suspension, and a concentration of 1 wt %.

TABLE 10

| Ph | After 15 minutes | After 60 minutes | After 360 minutes |
|---|---|---|---|
| Embodiment 1 | 8.7 | 8.69 | 8.53 |
| Embodiment | 8.90 | 8.82 | 8.71 |
| 1-c | | | |

Table 11 mentions the conductibility according to embodiment 1-c with a grain size of 5 μm, in a water suspension, and a concentration of 1 wt %.

TABLE 11

| Conductibility | After 15 minutes | After 60 minutes | After 360 minutes |
|---|---|---|---|
| Embodiment 1 | 326 | 537 | 1080 |
| Embodiment | 744 | 1097 | 1364 |
| 1-c | | | |

The following table 12 mentions the pH values of a tempered glass powder according to embodiment 12-c with a particle size of 5 μm, in a watery suspension, and a concentration of 1 wt %.

TABLE 12

| pH | After 15 minutes | After 60 minutes | After 360 minutes |
|---|---|---|---|
| Embodiment | 8.60 | 8.56 | 8.52 |
| 12 | | | |
| Embodiment | 8.68 | 8.60 | 8.54 |
| 12-c | | | |

Table 13 mentions the conductibility according to embodiment 12-c with a grain size of 5 μm, in a water suspension, and a concentration of 1 wt %.

TABLE 13

| Conductibility | After 15 minutes | After 60 minutes | After 360 minutes |
|---|---|---|---|
| Embodiment | 393 | 640 | 1021 |
| 12 | | | |
| Embodiment | 730 | 1208 | 1280 |
| 12-c | | | |

Table 14 shows the ion release in mg/l resulting from continuous diffusion after 1 h, 24 h, 72 h, and 168 h according to embodiment 2-c with a grain size of 5 μm, in a watery suspension, and a concentration of 1 wt %.

| | SiO₂ | Na₂O | B₂O₃ | Ag |
|---|---|---|---|---|
| After 1 h (mg/l) | | | | |
| Embodiment 2 | 227 | 1283 | 6929 | 0.63 |
| Embodiment 2-c | 781 | 3384 | 14019 | 6.1 |
| After 24 h (mg/l) | | | | |
| Embodiment 2 | 121 | 74 | 274 | 0.035 |
| Embodiment 2-c | 164 | 37.6 | 36.1 | 0.44 |
| After 72 h (mg/l) | | | | |
| Embodiment 2 | 70.8 | 23.8 | 60.8 | 0.02 |
| Embodiment 2-c | 61.3 | 4.6 | 4.70 | 0.36 |
| After 168 h (mg/l) | | | | |
| Embodiment 2 | 51.4 | 9.5 | 14.1 | 0.01 |
| Embodiment 2-c | 16.3 | 2.62 | 2.89 | 0.3 |

In this application, continuous diffusion means that, for instance, after 72 hours of water flow, the glass according to embodiment 2-c releases, for instance, still 0.36 mg/l silver.

It is evident that, at the beginning of diffusion, the decomposed glass releases noticeably more boron, sodium, and particularly silver ions than the non-decomposed glass. By means of the low chemical resistance of the phase containing boron, sodium, and silver, the antimicrobial effect is increased.

The boric phase is the highly reactive phase of the two-phase system with a very fast silver ion release, or very strong short-term antimicrobial effect. By means of its higher chemical release, the silicate-containing phase provides a slower silver release and the long-term antimicrobial effect of the glass.

Table 15 shows the silver ion release in mg/l resulting from continuous diffusion after 1 h, and after 24 h with a grain size of 5 μm, in a watery solution, and a concentration of 1 wt %.

TABLE 15

| Silver release in mg/l | 1 hour | 24 hours |
|---|---|---|
| Embodiment 12 | 9 | 10.8 |
| Embodiment 12-c | 32.9 | 68.8 |
| Embodiment 15 | 28.5 | 23.5 |
| Embodiment 19 | 28.5 | 50.5 |

Subsequently, embodiments for tellurium or germanium containing glass composition are mentioned. Such compositions are mentioned in table 16. The glasses according to table 12 were melted at 1,600° C. from row materials in a platinum pan and processed into half-finished products or ribbons. The ribbons were ground to grain sizes of up to 4 μm in a drum mill. Grain sizes under 4 μm were realized with attritor grindings in watery or non-watery media.

TABLE 16
Compositions (synthesis values) and characteristics of invention-based
tellurium and germanium containing glasses.

| | 2 | 3 | 4 | 5 | 6 | 7 | 8 | 9 | 10 | 11 | 12 | 13 | 14 | 15 | 16 |
|---|---|---|---|---|---|---|---|---|---|---|---|---|---|---|---|
| SiO₂ | 43 | 43 | 43 | 35 | 53.6 | 58.4 | 58.4 | 58.4 | 45 | 45 | 63 | 63 | 62.5 | 65 | 66 |
| P₂O₅ | 7 | 7 | 7 | 6 | 6 | 6 | 6 | 6 | 6 | 5.5 | | | | | |
| B₂O₃ | | | | | | | | | | | 30 | 29.5 | 28 | 32.8 | 26 |
| CaO | 25 | 25 | 25 | 29.5 | 20.2 | 17.8 | 17.8 | 17.8 | 24.5 | 23.5 | | | | | |
| Na₂O | 25 | 25 | 25 | 29.5 | 20.2 | 17.8 | 17.8 | 17.8 | 29.9 | 24.5 | 6 | 6 | 7 | 0 | 4.7 |
| TeO₂ | 0.5 | 1.0 | 0.001 | 1.0 | 5.0 | 0.01 | 0.1 | 0.1 | 0.1 | 0.1 | 0 | 0.5 | 0.1 | 0.2 | 0.1 |
| GeO₂ | | | | | | 0.1 | | | 0.5 | 2 | 0 | | | 2 | |
| ZnO | 0 | 0 | 0 | 0 | 0 | 0 | 5 | 0 | 0 | 0 | | | | | 3 |
| CuO | 0 | 0 | 0 | 0 | 0 | 0 | 0 | 2 | 0 | 0 | | | | | |
| K₂O | 0 | 0 | 0 | 0 | 0 | 0 | 0 | 0 | 0 | 0 | | | | | |
| MgO | 0 | 0 | 0 | 0 | 0 | 0 | 0 | 0 | 0 | 0 | | | | | |
| Al₂O₃ | 0 | 0 | 0 | 0 | 0 | 0 | 0 | 0 | 0 | 0 | | | | | |
| Ag₂O | | | | | | 0.1 | 0.1 | 0.5 | 1 | 0 | 1 | 1 | 0.9 | | 0.2 |

According to European pharmacopoeia third edition, the antibacterial effect of embodiment 2 from table 2 in 1.0 wt % watery suspension of a powder with 4 μm grain size is considered to be:

TABLE 17
1.0 wt % watery suspension embodiment 2:

| | | P. | | C. | |
|---|---|---|---|---|---|
| | E coli | aeruginosa | S. aureus | albicans | A. niger |
| Start | 350,000 | 250,000 | 270,000 | 330,000 | 240,000 |
| 2 days | 0 | 0 | 0 | 0 | 36,000 |
| 7 days | 0 | 0 | 0 | 0 | 100 |
| 14 days | 0 | 0 | 0 | 0 | 0 |
| 21 days | 0 | 0 | 0 | 0 | 0 |
| 28 days | 0 | 0 | 0 | 0 | 0 |

TABLE 18
Antibacterial effect of powder according to embodiment 6, 1.0 wt %
watery solution, European pharmacopoeia third edition:

| | | P. | | C. | |
|---|---|---|---|---|---|
| | E coli | aeruginosa | S. aureus | albicans | A. niger |
| Start | 350,000 | 250,000 | 270,000 | 330,000 | 240,000 |
| 2 days | 0 | 0 | 0 | 0 | 0 |
| 7 days | 0 | 0 | 0 | 0 | 0 |
| 14 days | 0 | 0 | 0 | 0 | 0 |
| 21 days | 0 | 0 | 0 | 0 | 0 |
| 28 days | 0 | 0 | 0 | 0 | 0 |

TABLE 19
Antibacterial effect of powder according to embodiment 12, 0.001 wt %
watery solution, European pharmacopoeia third edition:

| | | P. | | C. | |
|---|---|---|---|---|---|
| | E coli | aeruginosa | S. aureus | albicans | A. niger |
| Start | 350,000 | 250,000 | 270,000 | 330,000 | 240,000 |
| 2 days | 0 | 0 | 100 | 0 | 130,000 |
| 7 days | 0 | 0 | <100 | 0 | 50,000 |
| 14 days | 0 | 0 | 0 | 0 | 24,000 |
| 21 days | 0 | 0 | 0 | 0 | 2,800 |
| 28 days | 0 | 0 | 0 | 0 | 2,100 |

TABLE 20
Antibacterial effect of powder according to embodiment 13, 0.001 wt %
watery solution, European pharmacopoeia third edition:

| | | P. | | C. | |
|---|---|---|---|---|---|
| | E coli | aeruginosa | S. aureus | albicans | A. niger |
| Start | 350,000 | 250,000 | 270,000 | 330,000 | 240,000 |
| 2 days | 0 | 0 | 0 | 0 | 3,800 |
| 7 days | 0 | 0 | 0 | 0 | 100 |
| 14 days | 0 | 0 | 0 | 0 | 0 |
| 21 days | 0 | 0 | 0 | 0 | 0 |
| 28 days | 0 | 0 | 0 | 0 | 0 |

1. Antimicrobially active borosilicate glass with subsequent composition in wt % on oxide basis:

| | |
|---|---|
| SiO₂ | 40-80 wt % |
| B₂O₃ | 5-40 wt % |
| Al₂O₃ | 0-10 wt % |
| P₂O₅ | 0-30 wt % |
| Li₂O | 0-25 wt % |
| Na₂O | 0-25 wt % |
| K₂O | 0-25 wt % |
| CaO | 0-25 wt % |
| MgO | 0-15 wt % |
| SrO | 0-15 wt % |
| BaO | 0-15 wt % |
| ZnO | 0-30 wt % |
| Ag₂O | 0-5 wt % |
| CuO | 0-10 wt % |
| GeO₂ | 0-10 wt % |
| TeO₂ | 0-15 wt % |
| Cr₂O₃ | 0-10 wt % |
| J | 0-10 wt % |
| F | 0-10 wt % |

whereby the sum ZnO+Ag₂O+CuO+GeO₂+TeO₂+Cr₂O₃+B₂O₃ lies in the area between 5 and 70 wt %.

2. Antimicrobially active borosilicate glass with subsequent composition in wt % on oxide basis:

| | |
|---|---|
| SiO₂ | 60-80 wt % |
| B₂O₃ | 10-50 wt % |
| Al₂O₃ | 0-10 wt % |
| P₂O₅ | 0-30 wt % |
| Li₂O | 0-25 wt % |
| Na₂O | 0-25 wt % |
| K₂O | 0-25 wt % |
| CaO | 0-25 wt % |
| MgO | 0-15 wt % |
| SrO | 0-15 wt % |
| BaO | 0-15 wt % |
| ZnO | 0-30 wt % |
| Ag₂O | 0-5 wt % |
| CuO | 0-10 wt % |
| GeO₂ | 0-10 wt % |
| TeO₂ | 0-15 wt % |
| Cr₂O₃ | 0-10 wt % |
| J | 0-10 wt % |
| F | 0-10 wt % |

whereby the sum ZnO+Ag₂O+CuO+GeO₂+TeO₂+Cr₂O₃+B₂O₃ lies in the area between 10 and 75 wt %.

3. Antimicrobially active borosilicate glass with subsequent composition in wt % on oxide basis:

| | |
|---|---|
| SiO₂ | 61-75 wt % |
| B₂O₃ | 20-40 wt % |
| Al₂O₃ | 0-10 wt % |
| Li₂O | 0-12 wt % |
| Na₂O | 0-15 wt % |
| K₂O | 0-25 wt % |
| CaO | 0-25 wt % |
| MgO | 0-15 wt % |
| SrO | 0-15 wt % |
| BaO | 0-15 wt % |
| ZnO | 0-30 wt % |
| Ag₂O | 0-5 wt % |
| CuO | 0-10 wt % |
| GeO₂ | 0-10 wt % |
| TeO₂ | 0-15 wt % |
| Cr₂O₃ | 0-10 wt % |
| J | 0-10 wt % |
| F | 0-10 wt % |

whereby the sum ZnO+Ag₂O+CuO+GeO₂+TeO₂+Cr₂O₃+B₂03lies in the area between 10 and 65 wt %.

4. Antimicrobially active borosilicate glass according to claim 1, characterized by the fact that ZnO+Ag₂O+CuO+GeO₂+TeO₂+Cr₂O₃ lies in the area between 0.01 and 30 wt %.

5. Antimicrobially active borosilicate glass according to claim 1, characterized by the fact that the glass composition comprises Na₂O in the area from >0 to <7 wt %.

6. Antimicrobially active borosilicate glass according to claim 1, characterized by the fact that the glass composition comprises Al₂O₃ in the area from >3 to <7 wt %.

7. Antimicrobially active borosilicate glass according to claim 1, characterized by the fact that the glasses form at least two phases within the glass with different compositions, whereby one first phase forms a highly reactive phase and one second phase forms a deferred reactive phase.

8. Antimicrobially active borosilicate glass according to claim 7, characterized by the fact that the first highly reactive phase is a phase rich in borate and the second deferred reactive phase is a siliceous phase.

9. Antimicrobially active borosilicate glass according to claim 7, characterized by the fact that, compared to the siliceous phase, the phase rich in borate has an Ag concentration.

10. Fungicide and antimicrobial glass with the following composition in wt % on oxide basis.

| | |
|---|---|
| SiO₂ | 35-70 |
| B₂O₃ | 0-8 |
| Na₂O | 0-30 |
| K₂O | 0-5 |
| P₂O₅ | 1-15 |
| CaO | 4-30 |
| TeO₂ | 0-10 |
| Ag₂O | 0-2 |
| GeO₂ | 0-10 |
| ZnO | 0-8 |
| CuO | 0-5 |
| MgO | 0-8 |
| Al₂O₃ | 0-7 |

characterized by the fact that the sum TeO₂, GeO₂ is greater than 10 ppm and smaller than 15 wt %.

11. Fungicide and antimicrobial glass with the following composition in wt % on oxide basis.

| | |
|---|---|
| SiO₂ | 35-60 |
| B₂O₃ | 0-8 |
| Na₂O | 5-30 |
| K₂O | 0-5 |
| P₂O₅ | 1-15 |
| CaO | 4-30 |
| TeO₂ | 0-10 |
| Ag₂O | 0-2 |
| GeO₂ | 0-10 |
| ZnO | 0-8 |
| CuO | 0-5 |
| MgO | 0-8 |
| Al₂O₃ | 0-7 |

characterized by the fact that the sum TeO₂, GeO₂ is greater than 10 ppm and smaller than 15 wt %.

12. Fungicide and antimicrobial glass according to claim 1, characterized by the fact that the sum TeO₂, GeO₂ is greater than 10 ppm and smaller than 5 wt %.

13. Fungicide and antimicrobial glass or glass ceramics according to claim 1, characterized by the fact that the sum TeO₂, GeO₂ is greater than 10 ppm and smaller than 3 wt %.

14. Fungicide and antimicrobial glass according to claim 1, characterized by the fact that the sum TeO₂, GeO₂ is greater than 10 ppm and smaller than 1.5 wt %.

15. Fungicide and antimicrobial glass according to claim 1, characterized by the fact that the sum TeO₂, GeO₂ is greater than 10 ppm and smaller than 0.9 wt %.

16. Antimicrobially effective glass ceramics characterized by the fact that the source glass is glass according to claim 1.

17. Antimicrobially effective glass or glass ceramics characterized by the fact that the glass powder is glass with a composition according to claim 1.

18. Antimicrobially effective glass or glass ceramics powder according to claim 17, characterized by the fact that the size of the glass or glass ceramics particles has an average value of <20 μm.

19. Antimicrobially effective glass or glass ceramics powder according to claim 17, characterized by the fact that the size of the glass or glass ceramics particles has an average value of <10 μm.

20. Antimicrobially effective glass or glass ceramics powder according to claim 17, characterized by the fact that the size of the glass or glass ceramics particles has an average value of <5 μm.

21. Antimicrobially effective glass or glass ceramics powder according to claim 17, characterized by the fact that the size of the glass or glass ceramics particles has an average value of <1 μm.

22. Antimicrobially effective glass or glass powder or glass ceramics powder or glass ceramics according to claim 1 to be used in cosmetics.

23. Antimicrobially effective glass or glass powder or glass ceramics powder or glass ceramics according to claim 1 to be used in deodorant products.

24. Antimicrobially effective glass or glass powder or glass ceramics powder or glass ceramics according to claim 1 to be used in medical products and supplements.

25. Antimicrobially effective glass or glass powder or glass ceramics powder or glass ceramics according to claim 1 to be used in synthetic materials and polymers.

26. Antimicrobially effective glass or glass powder or glass ceramics powder or glass ceramics according to claim 1 to be used in paper hygiene.

27. Antimicrobially effective glass or glass powder or glass ceramics powder or glass ceramics according to claim 1 to be used in foods.

28. Antimicrobially effective glass or glass powder or glass ceramics powder or glass ceramics according to claim 1 to be used in cleaning supplies.

29. Antimicrobially effective glass or glass powder or glass ceramics powder or glass ceramics according to claim 1 to be used in paints and varnishes.

30. Antimicrobially effective glass or glass powder or glass ceramics powder or glass ceramics according to claim 1 to be used in plaster, hard plaster, ceramics, cement, and concrete.

31. Antimicrobially effective glass or glass powder or glass ceramics powder or glass ceramics according to claim 1 to be used in products for oral hygiene, dental care, mouth hygiene, palatal hygiene, palatal care.

32. Antimicrobially effective glass or glass powder or glass ceramics powder or glass ceramics according to claim 1 to be used in anti-fouling products.

33. Cosmetic formulation, encompassing at least 0.2 wt % of glass, glass ceramics, glass powder, or glass ceramics powder, whereby the glass or the source glass of the glass ceramics has a composition according to claim 1.

34. Medical formulation, encompassing at least 0.2 wt % of glass, glass ceramics, glass powder, or glass ceramics powder, whereby the glass or the source glass of the glass ceramics has a composition according to claim 1.

35. Deodorant, encompassing at least 0.2 wt % of glass, glass ceramics, glass powder, or glass ceramics powder, whereby the glass or the source glass of the glass ceramics has a composition according to claim 1.

36. Products in the area of paper hygiene, encompassing at least 0.2 wt % of glass, glass ceramics, glass powder, or glass ceramics powder, whereby the glass or the source glass of the glass ceramics has a composition according to claim 1.

37. Foods, encompassing at least 0.2 wt % of glass, glass ceramics, glass powder, or glass ceramics powder, whereby the glass or the source glass of the glass ceramics has a composition according to claim 1.

38. Cleaning supplies, encompassing at least 0.2 wt % of glass, glass ceramics, glass powder, or glass ceramics powder, whereby the glass or the source glass of the glass ceramics has a composition according to claim 1.

39. Paints and varnishes, encompassing at least 0.2 wt % of glass, glass ceramics, glass powder, or glass ceramics powder, whereby the glass or the source glass of the glass ceramics has a composition according to claim 1.

40. Plaster, cement, concrete, encompassing at least 0.2 wt % of glass, glass ceramics, glass powder, or glass ceramics powder, whereby the glass or the source glass of the glass ceramics has a composition according to claim 1.

41. Products for oral hygiene, dental care, palatal hygiene, palatal care, encompassing at least 0.2 wt % of glass, glass ceramics, glass powder, or glass ceramics powder, whereby the glass or the source glass of the glass ceramics has a composition according to claim 1.

42. Synthetic products, in particular, polymer, in particular, synthetic fiber, encompassing at least 0.2 wt % of glass, glass ceramics, glass powder, or glass ceramics powder, whereby the glass or the source glass of the glass ceramics has a composition according to claim 1.

43. Antimicrobially effective glass or glass ceramics characterized by the fact that the glass powder is glass ceramics according to claim 16.
